(19) United States
(12) Patent Application Publication
(10) Pub. No.: US 2011/0133940 A1
(43) Pub. Date: Jun. 9, 2011

(54) Multi-Sheet Glazing Unit With Internal Sensor

(76) Inventor: Yonatan Z. MARGALIT, Lawrence, NY (US)

(21) Appl. No.: 12/633,037

(22) Filed: Dec. 8, 2009

(51) Int. Cl. G08B 17/00; E06B 7/14; E05F 15/20; G08B 21/00; G06F 15/16

(52) U.S. Cl. 340/584; 52/204.593; 160/5; 340/602; 709/219

(57) ABSTRACT

A system and method is provided for a multi-sheet glazing unit including two or more sheets oriented by a spacer in a substantially parallel and spaced apart relationship. The sheets may include a peripheral edge and an air space or gap therebetween. A sensing device may be inside or in air communication with the air space. The sensing device may be used to sense an environmental condition data in the air space or gap.

### FIELD OF THE INVENTION

The invention relates to the field of multi-sheet glazing units having an air gap.

### BACKGROUND OF THE INVENTION

Glazing units may include multiple sheets, panes, or lites (e.g., of glass) positioned in a parallel orientation and separated from each other for example by spacers. The sheets may be hermetically sealed together around the edges thereof to form an enclosed air or gas space or dead air or gas chamber therebetween. The sealed chamber may be filled with inert gasses (e.g., argon or krypton), dehydrated air or other gasses to insulate or reduce heat transfer across the unit. Desiccant material may be used, e.g., typically within spacers, to adsorb residual moisture that may enter into the sealed unit over time to prevent condensation of moisture on the sheets.

In sealed units, the efficiency of the entire glazing unit may ultimately depend upon maintaining the unit's peripheral seal (unsealed units are also used). Should the seal in a unit intended to be sealed be broken or develop even the slightest leak, atmospheric air and moisture may enter the chamber. The desiccant material may become saturated by the atmospheric moisture and the moisture may collect within the chamber and fog the inner surfaces of the outer sheets. The presence of atmospheric air and moisture in the chamber may significantly reduce the efficiency and insulating value of the glazing unit.

In some instances a leak in the seal may be so small that it is undetectable by standard manufacturing tests. Consequently the unit may appear to be perfectly satisfactory, and may be sold and installed. Only after months or years are such defects revealed through the presence of condensation within the inner surfaces of the unit. Since repairing the unit is significantly more expensive and laborious once the unit is already installed, detecting unit malfunction prior to installation or at other times, e.g., during manufacture, delivery, installation, use, etc., may benefit both the manufacturer and the consumer.

### SUMMARY OF THE INVENTION

In an embodiment of the invention, a multi-sheet glazing unit may include two or more panes, lites or sheets oriented by one or more spacers in a substantially parallel and spaced apart relationship. The sheets may have a peripheral edge and an air space therebetween. A sealant may be provided along the peripheral edge of at least the outer sheets. A sensing device may be disposed in the air space or in air communication with the air space. The sensing device may be used to sense an environmental condition data in the air gap.

In an embodiment of the invention, a multi-sheet glazing unit may be monitored or maintained by, in a multi-sheet glazing unit, sensing environmental condition data in an air space and transmitting the sensed data to a remote receiver.

In an embodiment of the invention, a multi-sheet glazing unit may be monitored by sensing environmental condition data in an air space of the glazing unit. The air space may be formed between two or more sheets oriented by a spacer in a substantially parallel and spaced apart relationship. The air space may be formed by a sealant along the peripheral edge of at least the outer sheets. The data may be sensed by a sensing device in air communication with the air space.

### BRIEF DESCRIPTION OF THE DRAWINGS

The principles and operation of the system, apparatus, and method according to embodiments of the present invention may be better understood with reference to the drawings, and the following description, it being understood that these drawings are given for illustrative purposes only and are not meant to be limiting.

FIG. 1A is a schematic illustration of a multi-sheet glazing unit and a system for sensing internal conditions thereof according to an embodiment of the invention;

FIGS. 1B and 1C are cutaway illustrations of the glazing unit of FIG. 1A including electrical and mechanical temperature control devices according to an embodiment of the invention;

FIGS. 2A and 2B are cross-sectional illustrations of the multi-sheet glazing unit and a spacer of FIG. 1A, respectively, according to embodiments of the invention;

FIG. 2C is a schematically illustration of a portion of the unit of FIG. 2B according to some embodiments of the invention;

FIG. 2D is a schematic illustration of a non-permeable sealed edge of the glazing unit of FIG. 1A for deflecting moisture from entering the unit according to an embodiment of the invention;

FIG. 3 is a cross-sectional illustration of a spacer of FIG. 1A according to embodiments of the invention;

FIG. 4 is a cross-sectional illustration of the multi-sheet glazing unit of FIG. 1A having a conduit attached thereto according to an embodiment of the invention;

FIGS. 5A and 5B are schematic illustrations of a portion of the multi-sheet glazing unit of FIG. 1A having a gas supply device for filling the unit with insulating gasses and for identifying a region of an edge seal which may cause a failure according to embodiments of the invention;

FIG. 6 is a schematic illustration of a spacer in a multi-sheet glazing unit and pumps used to refill desiccant in the unit according to an embodiment of the invention;

FIGS. 7A and 7B show operations for manufacturing of the multi-sheet glazing unit of FIG. 1A according to an embodiment of the invention; and

FIG. 8 is a flowchart of a method according to an embodiment of the invention.

For simplicity and clarity of illustration, elements shown in the drawings have not necessarily been drawn to scale. For example, the dimensions of some of the elements may be exaggerated relative to other elements for clarity. Further, where considered appropriate, reference numerals may be repeated among the drawings to indicate corresponding or analogous elements throughout the serial views.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulates and/or transforms data represented as physical, such as electronic, quantities within the computing system's registers and/or memories into other data similarly represented as physical quantities within the computing system's memories, registers or other such information storage, transmission or display devices.

A multi-sheet glazing unit, as it is referred to herein, may include any fenestration, window, door, curtain wall, skylight, or structure having two or more spaced sheets, panes, or lites, typically designed to permit the passage of light.

Embodiments of the invention provide a multi-sheet glazing unit having an enclosed air space or gap with a sensor disposed therein for measuring environmental conditions, e.g., pressure, humidity, relative humidity, temperature, air density, heat transfer, insulating coefficient, etc., within the air gap. The sensed data may be analyzed, e.g., automatically or manually, to monitor and maintain for example the insulating efficiency or other qualities of the glazing unit. Various uses may be made of the data. For example, when sub-optimal levels of one or more environmental conditions are sensed that deviate from predetermined stable threshold ranges, warnings may be triggered to alert a technician to repair the unit prior to unit failure. Alternatively, the unit may include automatic maintenance components, e.g., pressure release or suction valves, that maintain stable environmental conditions within the air gap of the unit.

Embodiments of the invention also provide a multi-sheet glazing unit having easily removable or repairable parts, for example, adapted for removal or repair while the unit is installed to decrease the cost of maintenance. The unit may be repaired upon failure or prior to failure, when the sensed conditions within the air gap of the unit deviate from stable levels to indicate that future failure is likely.

In one embodiment there is provided a system and method to easily and inexpensively detect and repair malfunctions in glazing units prior to unit failure, thereby extending the operational lifetime of the units.

Multi-Sheet Glazing Unit with Internal Sensing Device

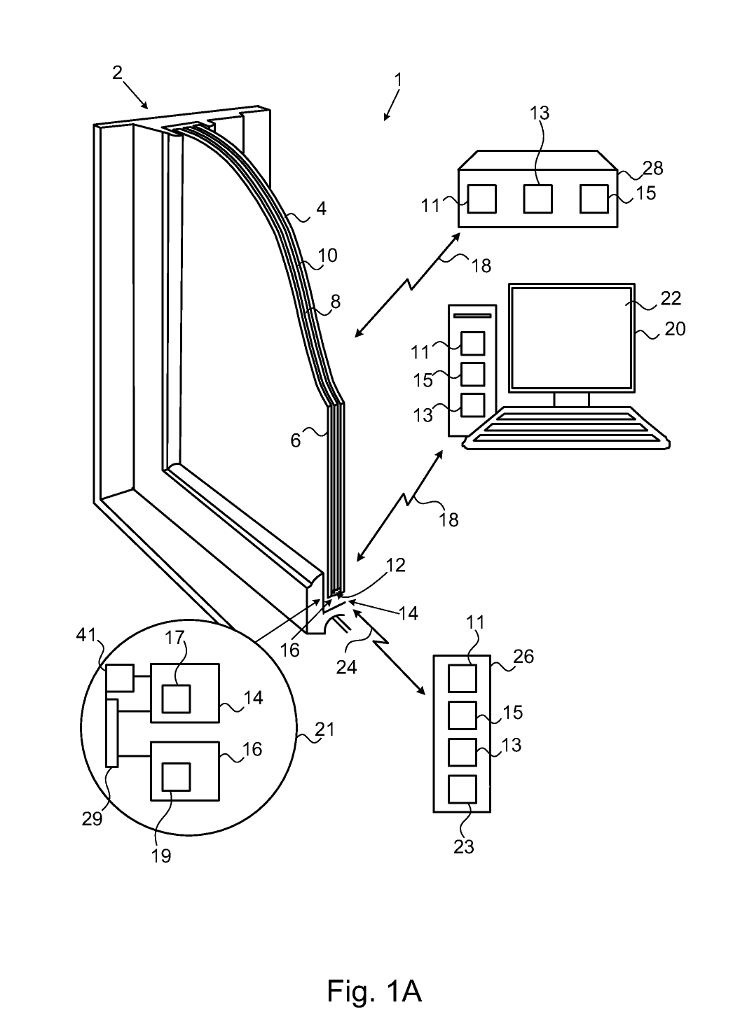

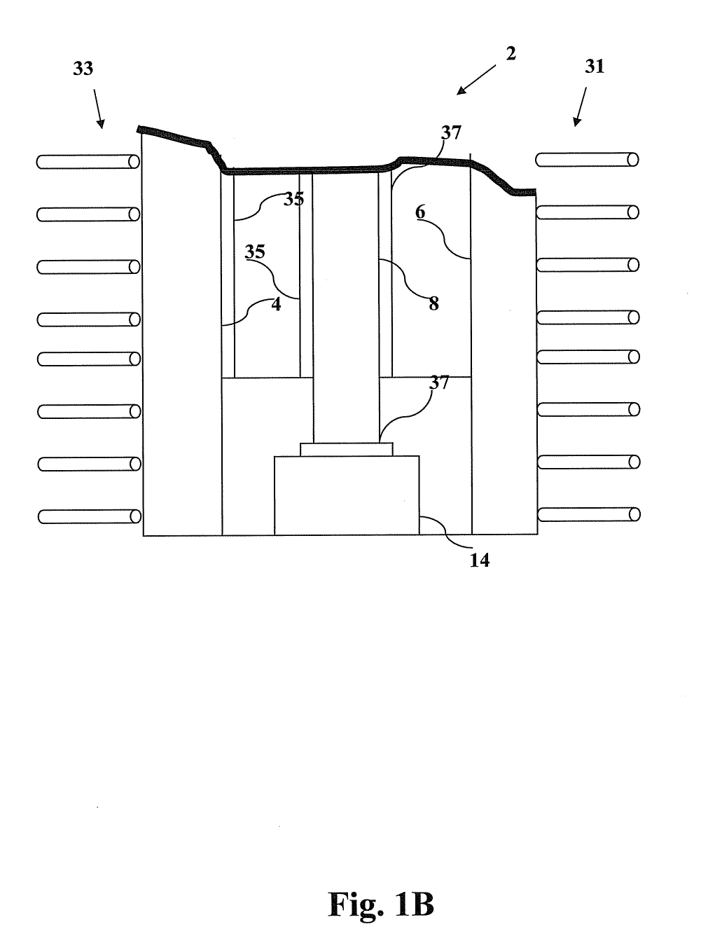

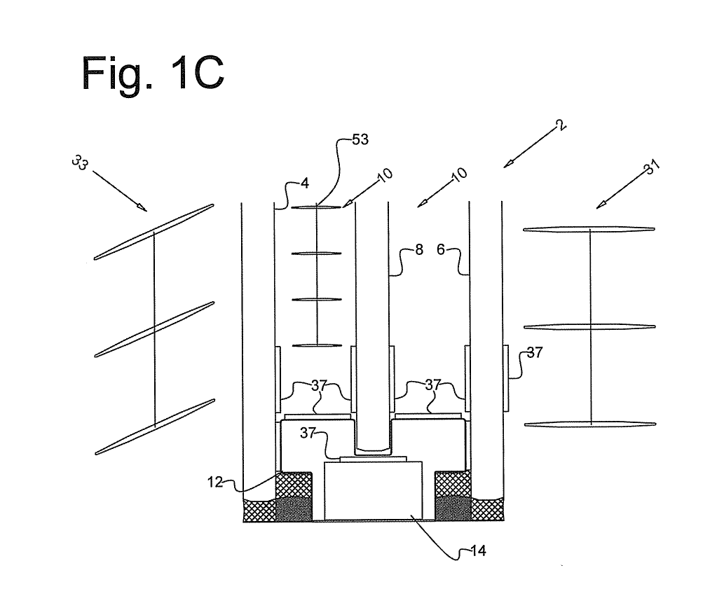

Reference is made to FIG. 1A, which schematically illustrates a multi-sheet glazing unit 2 and a system 1 for sensing internal conditions thereof according to an embodiment of the invention. Multi-sheet glazing unit 2 may include outer sheets 4 and 6. Outer sheets 4 and 6 may be oriented substantially parallel to each other and spaced apart by spacers 12. In alternate embodiments, the sheets need not be parallel. Spacers 12 typically surround the peripheral edge of outer sheets 4 and 6 to form an air space or chamber 10. In some embodiments not all spacers 12 are identical, e.g., a bottom spacer may have a different structure than other spacers. Chamber 10 may be partially or completely (e.g., hermetically) sealed all or in part, for example by a sealant material or a combination of sealants and structures bridging the gap between outer sheets 4 and 6 and across spacers 12. In other embodiments there may be one or more openings or air passage into and/or out of chamber 10, e.g., penetrating or through a sheet or spacer.

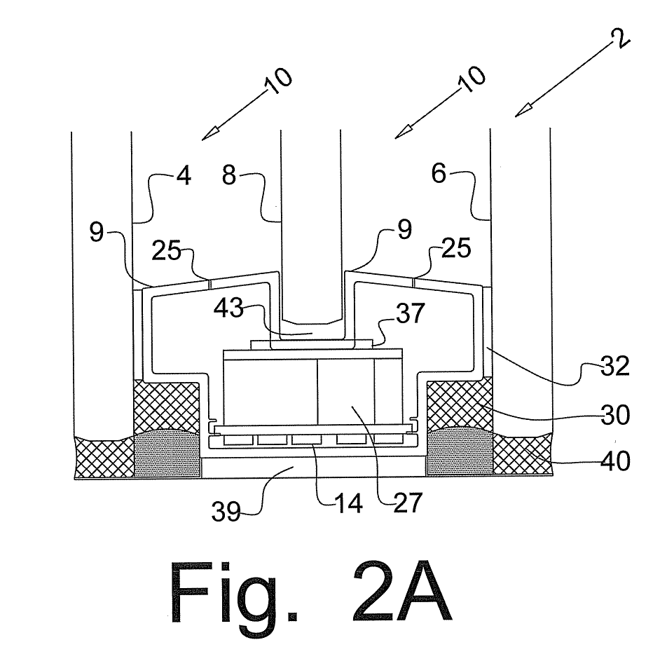

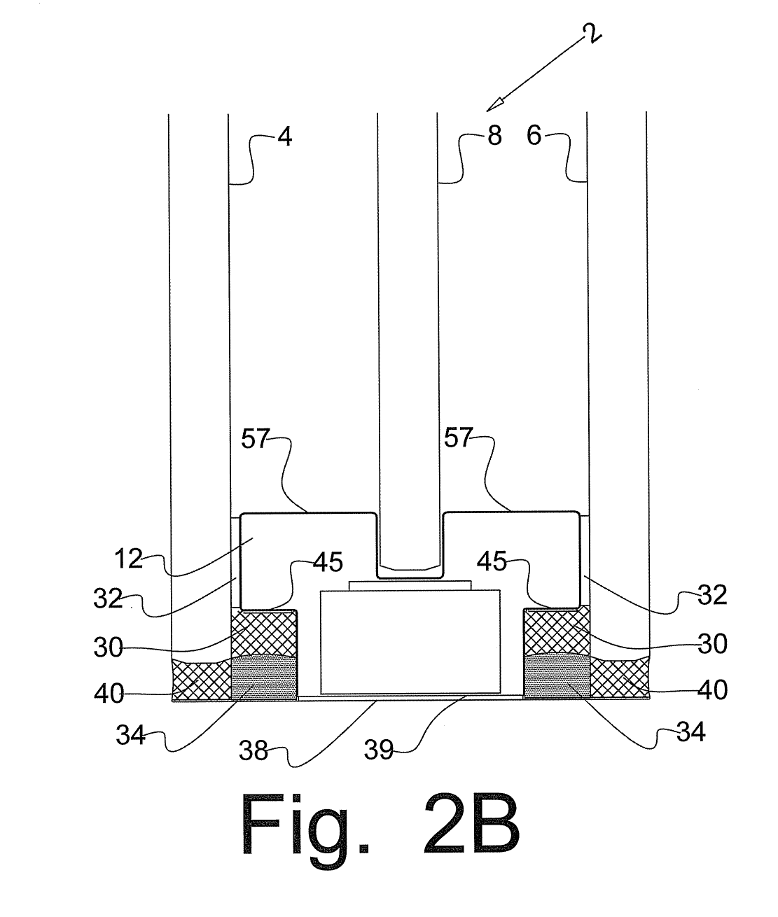

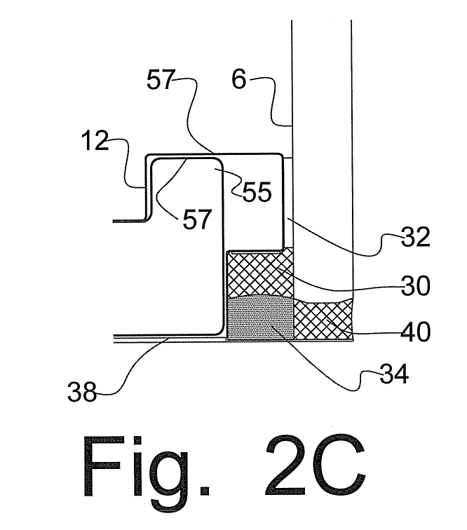

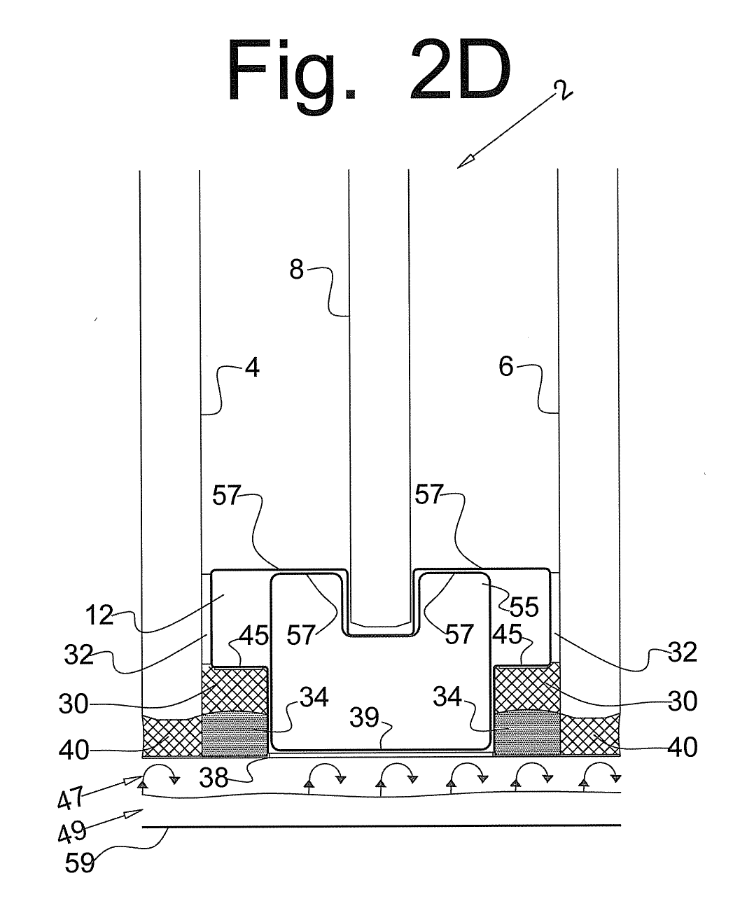

One or more inner sheets 8 (e.g., shown in FIG. 2) may be positioned between the outer sheets 4 and 6 (inner sheets need not be used). The peripheral edges of the inner sheets 8 may be secured to spacers 12 or other structures using for example tension connections such as springs or rigid connection to position inner sheets 8 in a parallel orientation to outer sheets 4 and 6. Other connection methods may be used. Inner sheets 8 may further divide chamber 10 into multiple sub-chambers to reduce heat transfer across glazing unit 2. Inner sheets 8 may be less rigid and more fragile than outer sheets 4 and 6 and may be spaced from the edge of glazing unit 2 for protection from shock and moisture.

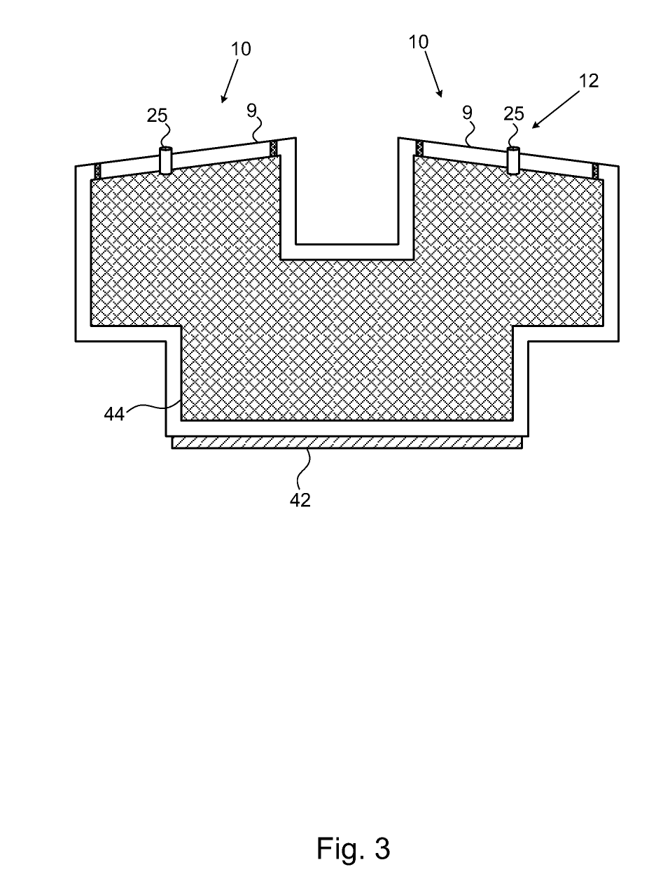

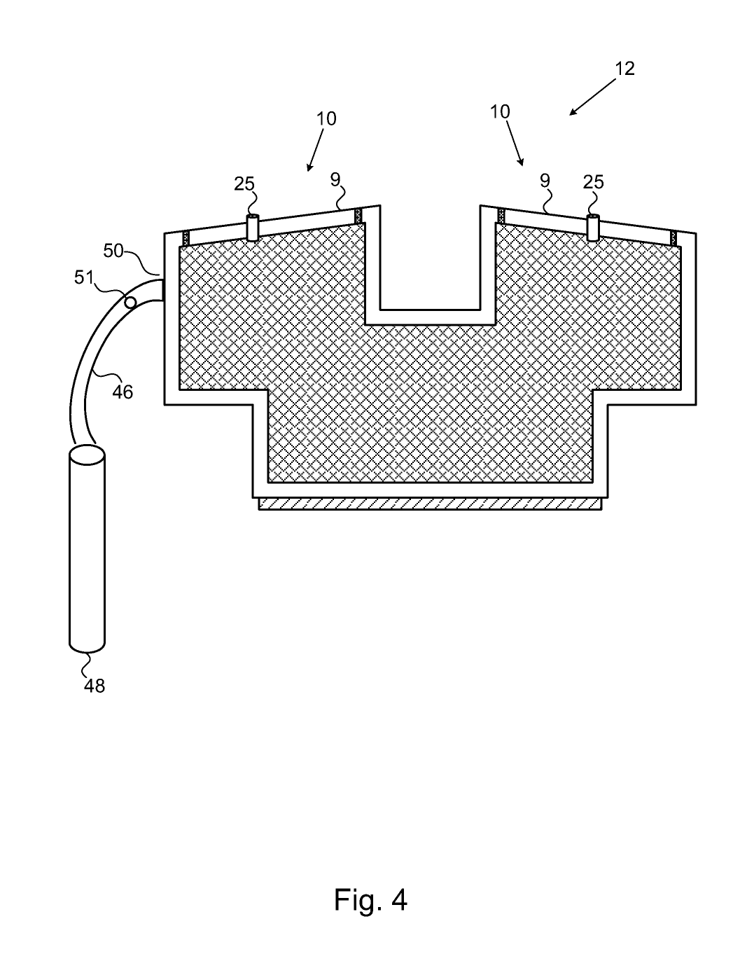

Chamber 10 may be filled with one or more insulating gasses, e.g., dehydrated air, a heavier-than-air composition such as nitrogen (N₂) and/or inert gasses such as argon, krypton, or a combination thereof, to further reduce heat transfer. Chamber 10 may be dehydrated, e.g., by desiccant material (e.g., desiccant 44 in FIG. 3). The desiccant material may be located within chamber 10 (e.g., in spacer 12) or in communication with chamber 10, e.g. in an external desiccant conduit, tube or valve (e.g., tube 46 in FIG. 4). Desiccant material may include, e.g., silica gel, sodium, potassium, or calcium crystalline hydrated aluminosilicates, molecular sieve, and/or activated clay (e.g., montmorillonite and bentonite clay), or any suitable material capable of dehydrating in an unsaturated state. In some embodiments desiccant material may be granular or powder, or in another semi-flowable form, allowing for easy removal and replacement by causing the material to flow out of and in to the unit 2. In other embodiments, desiccant material may be recharged from within the unit 2.

Glazing unit 2 may include one or more internal sensing device(s) 14. Sensing device 14 may be located within the air space chamber 10 of glazing unit 2, e.g., spacers 12 or chamber 10, or may be located external to glazing unit 2, e.g., in a tube, conduit, channel, cartridge or valve in air communication with chamber 10 (e.g., tube 46 or cartridge 48 in FIG. 4). When sensing device 14 is connected to or disposed within a tube or cartridge, the device 14 itself may be physically external to glazing unit 2 while the data collected thereby via an air channel into chamber 10 may be data relating to the internal environment of glazing unit 2. Sensing device 14 may measure (or data sensed by device 14 may be used to derive) one or more environmental conditions within chamber 10, e.g., pressure, humidity, relative humidity, air density, thermal conductivity, temperature, vibrations, shock, air density, wind loads, heat loads, cold or hot spots at one or more glazing units 2 relative to others in a building, etc. For example, a building manager may use measurements from sensing devices 14 to identify issues or failures in the building itself, such as hot spots or areas of the building where excessive wind loads compress glazing unit 2. Sensing device 14 may include a wireless window cavity humidity monitoring device provided by Echoflex Solutions, Inc. Other devices, from other suppliers, may be used. Sensing device 14 may include a micro-sensor, a sensor chip, a film or laminate sensor material coating an inner surface of chamber 10, e.g., for measuring light. A sensing device 14 for detecting pressure may include a piezoelectric pressure sensor, a capacitor sensor, an electromagnetic sensor, a barometer or other device. A sensing device 14 for detecting physical strain or force on a joint or seal may include a load cell, i.e., an electronic device used to convert a force into an electrical signal. Sensing device 14 may be self-powered by a long life or rechargeable integrated battery, power induction devices, or preferably a small solar panel for example mounted on a PCB board or mounted or laminating sheets 4, 6 and/or 8.

An exploded view 21 of FIG. 1A shows sensing device 14 and transmitter/transceiver 16 each having a power source 17 and 19, respectively, although one integrated power source may be used. Power sources 17 and 19 may provide power to sensing device 14 and transmitter 16, respectively, and may additionally collect energy, e.g., using photovoltaic (PV) cells or laminate (e.g., PV cells or laminate 37 of FIG. 1B). Sensing device 14 may be integral or operatively coupled to a transmitter 16 for transmitting sensed data to a remote computing device 20 (e.g., a computing device, a receiver, a recorder, etc.). Sensing device 14 and transmitter 16 may be electrically connected via wired or wireless connection. Transmitter/transceiver 16 may transmit sensed data for example via signals 18, e.g., periodically according to a clock cycle or a counter of an internal processor 29, in response to a changed environmental condition, continuously, or in response to receiving a command or signal, such as a radio frequency (RF) signal. In one embodiment, a mobile device 26, e.g., a hand-held receiver or RF identification (RFID) scanner, or “wand” may transmit short-range radio signals 24, via transceiver 15. Alternately, a mobile or handheld device 26 may include only reception capabilities. Transmitter 16 may include or be an RFID tag or any other suitable transmitter, which upon excitation by the energy of short-range radio signals 24, may transmit sensed data from sensing device 14. Mobile device 26 may include a receiver to collect the sensed data from sensing device 14 via RFID signals or any radio signals. Device 26 need not be an RFID device; for example it may transmit using internal power. Mobile device 26 may later upload the data into computing device 20 or analyze or display to a user the data in mobile device 26 itself. Mobile device 26 may include a display 23 for displaying sensed or processed data to a user. Transmitter 16 may transmit sensed data to computing device 20 and/or mobile device 26. (In different embodiments only one or more mobile devices 26 may be used, or only one or more computing devices 20 may be used.) When mobile device 26 energizes transmitter 16, data is typically beamed to mobile device 26, and not to computing device 20. If both computing device 20 and mobile device 26 are used, mobile device 26 may send or download data to computing device 20, although in some embodiments only mobile device 26 may be used. Alternatively, after mobile device 26 triggers the transmission of the sensed data, the data may be directly received by computing device 20. Since in some embodiments mobile device 26 provides power for transmitting sensory data, glazing units 2 may lack batteries and other electronic power components, thereby reducing power maintenance needs (e.g., recharging glazing units 2) and cost for installing individual power sources in each glazing unit 2. Alternately an internal power unit such as long-life batteries or solar or temperature collectors may be used.

Computing device 20 may be or include, for example, a desktop computer, laptop computer, a mobile or handheld computer. In some embodiments computing device 20 may include or be associated with a remote server 28. Additionally or alternately, a mobile device 26, such as, an RFID scanner or any radio scanner, may be used, and may include or be associated with a remote server 28. Computing device 20, mobile device 26, and remote server 28 may include a processor 11, a memory or storage 13 and a receiver or transceiver 15 (the same reference numeral is used for each of the processors, storage units, and transceivers for convenience).

Processing Data Sensed within Multi-Sheet Glazing Unit

Computing device 20, mobile device 26, and/or remote server 28 may receive raw data from sensing device 14, e.g., pressure, temperature, and humidity or relative humidity values, and other data such as corresponding times of detection, window or unit identification and/or data processed therefrom. In some embodiment, computing device 20 may analyze and derive information from the sensory data, e.g., rate of change of environmental data, thermal conductivity, operational efficiency, probability or predicted time of components or the entire unit failure, system diagnosis, recommended time and instructions for repair, such as time for replacing desiccant, time for refilling insulating gas, etc. Computing device 20 may also provide the raw data or organized data to a user on display 22.

The optimal state of glazing unit 2 (e.g., having no malfunctions, or not operating out of specification) may be defined by a set of one or more “optimal” or “stable” threshold values, limits or ranges at which or within which glazing unit 2 is determined to properly function. Stable threshold ranges or limits may be generated or defined for each of the conditions sensed by sensing device 14, e.g., pressure, humidity, air density, air quality, thermal conductivity/insulating value, vibrations on the glass, strain or stress of the peripheral air seal, etc. The stable threshold ranges for these conditions may depend on the structural and material properties of glazing unit 2, e.g., including the type of insulating gas or desiccant material used and other design properties, such as the number of inner sheets 8, the material properties and type of the air seal, e.g., fully enclosed, partially enclosed or open, the pressure at which glazing unit 2 was filled, sealed, or evacuated, etc. For example, krypton gas, which is more insulating but also more expensive than argon gas, may or may not be used. Thus, the choice of gas typically affects the stable thermal conductivity ranges of glazing unit 2. The operational efficiency of glazing unit 2 (which may degrade over time due to leaks or malfunctions) may be defined by the difference (if any) between the measured values or ranges of internal conditions detected by sensing device 14 and the corresponding optimal or stable ranges, thresholds or limits for the glazing unit 2. Other measures of the efficiency of glazing unit 2 may be used.

In some embodiments, the efficiency of glazing unit 2 may depend on environmental conditions external to glazing unit 2. In such embodiments, one or more external sensing device(s) may be used in combination with internal sensing devices 14 to measure external conditions. For example, the thermal conductivity of glazing unit 2 may be defined, for example, by the thickness across glazing unit 2, the cross-sectional area of glazing unit 2, and/or the temperature difference across glazing unit 2. To determine the temperature difference, and thus the thermal conductivity of glazing unit 2, external temperature sensing devices or internal temperature sensing devices 14 may be placed on opposite or spaced apart surfaces of glazing unit 2.

Displaying Sensed Data and Alerting Users of Problems

In one embodiment, environmental values received by a device (e.g., computer 20 or mobile device 26) may be simply displayed to a user, e.g., on a display 22 or 23 on computer 20 or mobile device 26. The user may then react to the values if they indicate a malfunction, out of specification operation, or that repair or maintenance is needed. The specific identification of the unit producing the relevant data may be displayed.

In other embodiments, when sensing device 14 senses condition values that are outside of a predetermined stable value range (e.g., sub-optimal values), or are above or below a threshold or limit, computing device 20 may take actions such as record the exception in a table or list viewable by a user, trigger a warning or alert, or other action. The warning may be a continuous, periodic, or one-time use alarm, blinking lights, a signal via a network (e.g., the Internet), or information displayed on display 22, display 23, etc. For example, computing device 20 may display the sub-optimal sensed values, an absolute or percentage deviation from the optimal value ranges (or above or below a threshold or limit), a “high” or “low” flag indicating sensed values above or below the optimal value threshold ranges, respectively, a warning for system malfunction, out of specification operation, or failure, a time within which the repair should be made such as “immediately,” “within one year,” or “during next scheduled repair” (e.g., when the repair schedule is known or estimated), or instructions for repairing glazing unit 2. For example, when sensing device 14 senses sub-optimal pressure values, computing device 20 may display “re-fill insulating gas” and/or “repair seal.” When sensing device 14 senses sub-optimal humidity values, computing device 20 may display “replace desiccant.” The specific identification of the unit affected may be displayed. For complex repair diagnoses, e.g., where the cause of malfunction is unknown, computing device 20 may provide a plurality of possible diagnoses, warnings, or repair recommendations, e.g., statistically ordered according to their predicted accuracy.

Computing device 20 or mobile device 26 may provide a user interface by which a user may monitor and control sensory data. The user interface may include a control module to select which one or more of the plurality of environmental conditions is to be displayed. The user interface may include a control module to select the manner in which the data is displayed. For example, the environmental conditions may be displayed as one-dimensional values, two-dimensional charts or three-dimensional profiles.

Computing device 20 or mobile device 26 may provide a two or three-dimensional visualization of glazing units 2. When a large number of glazing units 2 are used (or only a small number of glazing units 2 as typically are used in a home or small building), e.g., installed in a curtain wall, the sensed data specific to each unit may be transmitted with an identification (ID) code tagged onto the sensed data. For example, a unique numeric tag may be provided for each of glazing units 2 in the assembly so that collected data may be easily compared. In this way, computing device 20 may individually analyze the sensed data associated with each glazing unit 2 and reconstruct an accurate spatial arrangement of visualizations. Sensing device 14 may also include a global positioning system (GPS) or other position and/or orientation sensor to determine for example the latitude, longitude and elevation of a glazing unit 2, for example for positioning the unit. Such information may be used (typically conjunction with other information sent by a sensor), e.g., to quickly locate malfunctioning units. Information specific to each glazing unit 2, such as current or most recent sensory data, sensory data history, repair history, actual geographical location, and/or standard unit specifications may be retrieved by a user by selecting (e.g., clicking) on a visualization of the unit on a monitor or display device. Such information and optionally graphics visualization software for running the user interface may be stored in computing device 20, mobile device 26, or remote server 28. In some embodiments, the information may be transferred to computing device 20 (e.g., uploaded from server 28 or mobile device 26 or accessible via a password protected client Internet webpage) where the user interface may be run to locally to monitor glazing units 2.

Alternatively or additionally, glazing unit 2 may include an internal processor 29 (e.g., a programmable chip, a micro-processor chip or PCB board disposed within glazing unit 2) in operative communication with or included within sensing device 14 and transmitter/transceiver 16. Transmitter/transceiver 16 may receive the programmed data from computing device 20, mobile device 26, or remote server 28 or the other sensing devices 14 in other glazing units 2. Glazing unit 2 or device 14 may also include an internal memory 41, e.g., a short-term memory buffer to temporarily store sensed data until it is transmitted or a long-term memory to store a history log of sensed data within the unit. Internal memory 41 may be in operative communication with or included within internal processor 29, sensing device 14, and/or transmitter 16. In such embodiments, some or all intermediate processing, warnings, and/or displays, may be executed within glazing unit 2. Glazing unit 2 may include internal indicators, such as electronic indicators, e.g., simple light emitting diodes (LED) (e.g., of different condition-specific colors), blinking lights or alarms, digital index, scroll read-out, or other indicators to indicate malfunctions. Glazing unit 2 may also include non-electronic internal maintenance indicators such as a manual switch that releases when conditions exceed a stable threshold or alternatively, films, crystals, and/or desiccant materials which change color, opacity or other physical properties based on ambient moisture levels in glazing unit 2. In one embodiment, the indicators may be condition-specific and may indicate the proper function or malfunction for each type of individual environmental condition, e.g., pressure, temperature, etc. Alternatively, the indicators may be maintenance-specific and may individually signal the type of maintenance requirement, e.g., recharge/refill desiccant material, refill insulating gas, etc.

Arrangement and Operation of Sensing Device within Multi-Sheet Glazing Unit

Various types and arrangements of sensing devices 14 may be used. In FIG. 2 sensing device 14 is disposed within spacer 12, although other or additional locations throughout glazing unit 2 may be used. In some embodiments, multiple sensing devices 14 may be used. In one embodiment of the invention, where the glazing unit includes one or more additional inner sheets 8 to divide chamber 10 into multiple sub-chambers, multiple sensing devices 14 may be used to independently collect sensory data specific to each sub-chamber. Environmental conditions between sub-chambers may vary. For example, a sub-chamber facing the interior of a building is better insulated than a sub-chamber facing the exterior of the building. The degree with which the conditions of different sub-chambers vary may depend on the overall ambient environmental conditions in which glazing unit 2 is placed. For example, the more extreme (hot/cold, high/low pressure, etc.) the greater the expected difference between sub-chamber conditions. However, when glazing unit 2 fails or begins to fail (e.g., outside air entered the unit through a leak in the seal), the expected relationship between sub-chamber conditions are violated. The sub-chamber conditions from the multiple sensing devices 14 may be analyzed by computing device 20 to determine, not only failures, but the locations of such failures in glazing unit 2. If for example, sensing devices 14 consistently detect substantially the same conditions (e.g., a lesser degree of variation than expected) in two or more neighboring sub-chambers, computing device 20 may determine that inner sheet 8 separating the sub-chambers has failed. To distinguish multiple sensing devices 14 in a single glazing unit 2, in addition to the ID code for glazing unit 2, each of the multiple sensing devices 14 may transmit sensed data with an ID code added to it. If a glazing unit 2 includes only one sensing device 14, the ID code of the sensing device 14 may be considered to be the ID code of the glazing unit 2.

If computing device 20 displays a visualization of glazing unit 2, the failed region may be labeled (e.g., by symbols, blinking markers, highlighting or color coding). A technician may view the visualization to determine the approximate location or source of the problem. Knowledge of the component or location of failure may reduce the cost and labor for a technical to repair glazing unit 2. For example, if a failure is attributed to a sudden influx of moisture due to a seal leak located in the sub-chamber on the side of glazing unit 2 interior to a building, glazing unit 2 may be repaired without removing the entire unit. In another example, if failure is caused over a duration of time (e.g., years) typically attributed to a saturation of the desiccant material (e.g., and not to a significant leak in the unit's seal), the desiccant material may be replaced without resealing the unit, as described in further detail herein. In yet another example, if the failure is attributed to inner sheet 8, a technician may immediately order a new inner sheet 8 without wasting time and effort to disassemble glazing unit 2 to determine the source of failure.

In another embodiment, glazing unit 2 may include a sensor array of multiple sensing devices 14, positioned at spatial intervals within the same chamber of glazing unit 2 to sense condition profiles as they vary spatially throughout glazing unit 2. Implementing an array of sensing devices 14 may provide a sensory profile, e.g., a two or three dimensional representation of sensory conditions throughout glazing unit 2. The sensory profile may include discrete sensory values for each sensing device 14 at each point in time, e.g., forming a step-function having values that vary with location (or sensors) and time. Alternatively, the sensory profile may be a continuous function of location (or sensors) and time interpolated from the discrete sensed data. The sensory profile may be displayed to a user, for example, as a color field. The sensory profile may be displayed overlaying, instead of, or adjacent to, a visualization of glazing unit 2. The color field may be a function of data sensed at corresponding locations of glazing unit 2 being displayed. Alternatively, instead of a color field, symbols, highlighting or other markers may be used. In one example, a user may drag a cursor (e.g., using a pointing device) over the visualization of glazing unit 2 and sensory data corresponding to that point may be displayed, e.g., in an adjacent window. The sensory profile may be used to determine spatial fluctuations of conditions within glazing unit 2 that may be attributed to a malfunction therein. For example, in the moments after a seal leak, the region surrounding the leak may experience a change in pressure before the effects of the leak precipitate to the neighboring regions. Display 22 may display the spatial fluctuations or pressure gradients across glazing unit 2 as a function of time. In one example, the sensory profile may be displayed (as a function, graph or color chart) at a specific time or time interval. A time bar or clock may be provided to manually or automatically change the time at which the data displayed was sensed to see the change in glazing unit 2 conditions at different times. Such change in the spatial profile of data sensed at different times may be analyzed by a technician or automatically by computing device 20 to determine and identify the spatial location of a malfunction or failure in glazing unit 2. A sensor array of multiple sensing devices 14 may also be useful for analyzing the effect of different regions of glazing unit 2 being exposed to different external conditions, e.g., when the window is partially shaded.

This and other data may be shown on display 22 of computing device 20 and/or display 23 of mobile device 26. This and other data may be computed, processed and/or stored using processor 11 of computing device 20, mobile device 26, and/or remote server 28.

Simulations of Predicted Conditions of Multi-Sheet Glazing Unit

In one embodiment, computing device 20 may simulate future conditions. A user may select one of a plurality of possible maintenance procedures (e.g., to refill desiccant) and computing device 20 may simulate a predicted resultant effect. In another embodiment, based on the current sensed device conditions, computing device 20 may simulate corresponding device conditions in the future (e.g., in 6 months, one year, two years, five years, etc.) to estimate the time and budget for repairs and/or replacement of one or more glazing units 2. A time bar or clock may be provided to manually or automatically change the future time for which the data is predicted.

Examples (Non-Limiting) of Uses for Internal Sensing Device

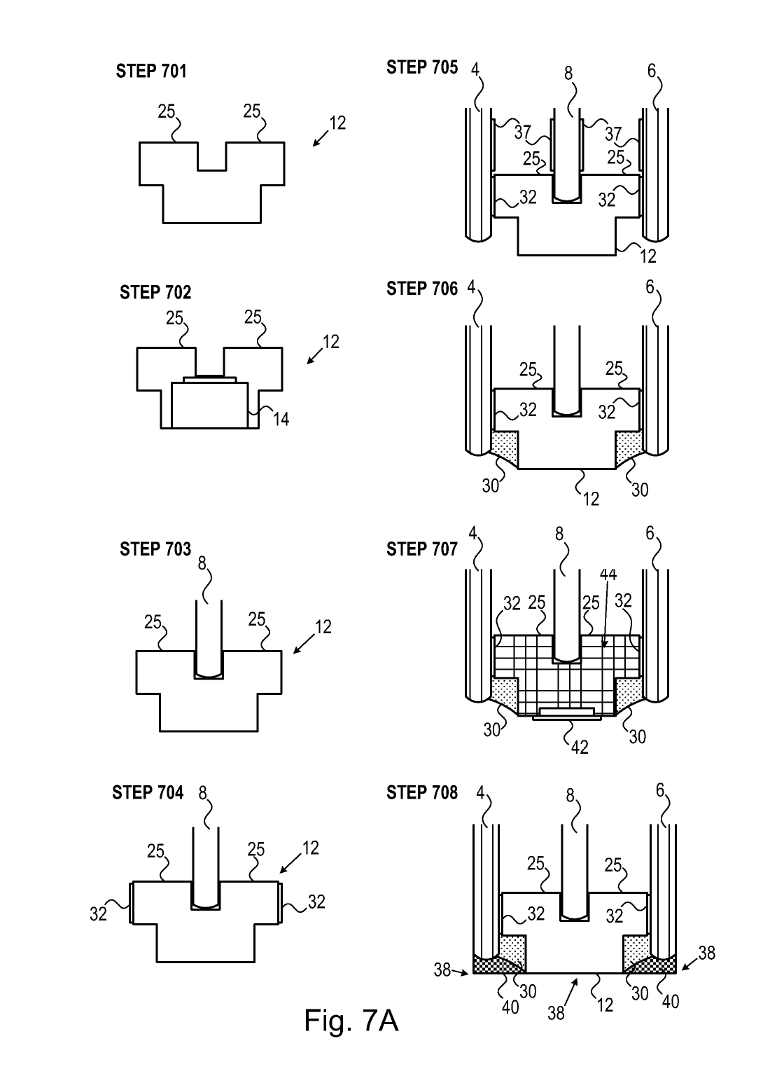

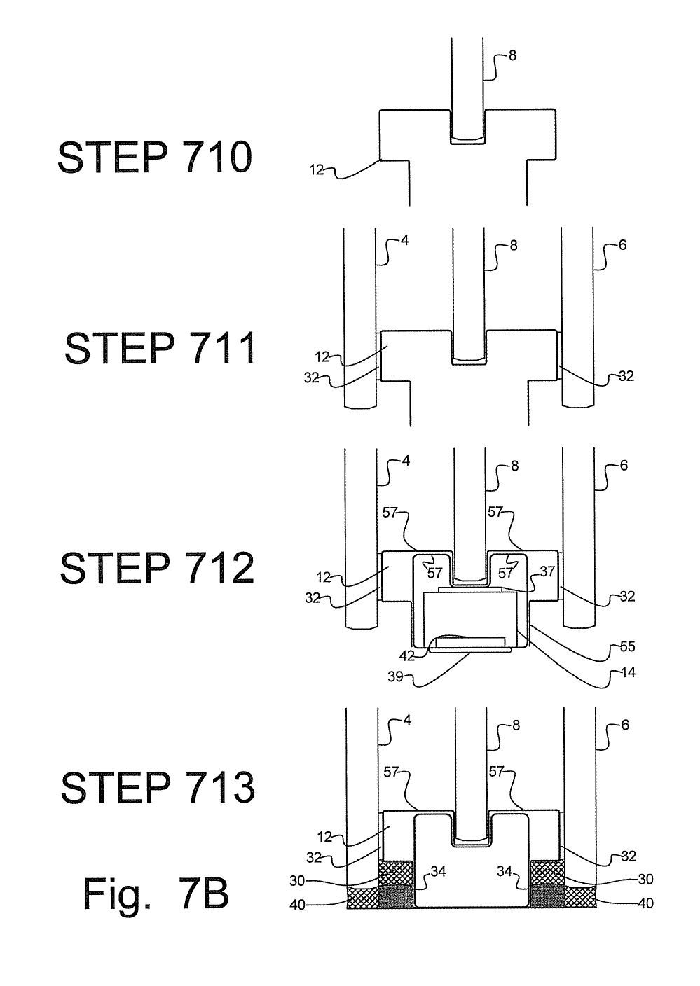

In one embodiment for detecting manufacturing defects, at various stages or times in the assembly (e.g., manufacturing steps 701-708 of FIG. 7), delivery, or installation processes, a mobile device 26 may scan and collect sensory data from glazing unit 2. For example, one or more mobile devices 26 may be positioned along one or more locations along an assembly line to collect sensory data from glazing unit 2 following predetermined manufacturing steps (e.g., after chamber 10 is filled with insulating gas and sealed). In another example, when glazing unit 2 are manufactured in several different facilities or by several different teams or individuals, after each has completed their work, they may scan glazing unit 2 with mobile device 26 to record the state of glazing unit 2 while in their custody. Accordingly, if glazing unit 2 is damaged or fails, there is a record of the stage of manufacture at which the failure occurred. This record may identify the specific facility or individual(s) responsible for damaging each glazing unit 2, and also the cause of device failure, e.g., the components or assembly process after which the sensory data indicates glazing unit 2 failure. In another example, for detecting malfunctions of glazing units 2 which are already installed in a building, a maintenance technician equipped with mobile device 26 may circulate throughout the building and scan each room or glazing unit 2. In another example, multiple fixed mobile device 26 may be located in a building, e.g., one in each room or several per floor in a building to receive sensed data from transmitters 16 in each glazing unit 2 in the building.

Mobile device 26 may be positioned in the building within a transmission or reception range of transmitters 16. Mobile device 26 may include RFID receivers or any radio receiver. When an RFID mobile device 26 is used, the transmission range may be relatively short-range although other transmission devices and ranges may be used. In another example, sensed data may be stored at a centralized location, e.g., in remote server 28 or computing device 20 and mobile device 26 may be used to scan or retrieve sensed data therefrom via transmission and reception of signals between the devices.

Reference is made to FIGS. 1B and 1C, which schematically illustrate close-up views of glazing unit 2 for operating electrical and mechanical temperature control devices according to some embodiments of the invention. Data sensed by sensing device 14 may trigger a corresponding change in the temperature control of glazing unit 2.

In some embodiments, glazing unit 2 may include photovoltaic (PV) 37 cells or laminate to collect energy from the sun. PV 37 laminate may be for example a film or coating disposed on an inner sheet such as inner sheets 8 and/or on outer sheets 4 and 6, or may be embedded within or spread throughout sheets or panes. Alternatively or additionally, PV 37 cells may be physically and/or operatively connected to sensing device 14 (e.g., a small PV cell to power only device 14 may be included on or near device 14). In one embodiment, PV 37 cells may be positioned in a sink of spacer 12 cradling inner sheets 8. These PV 37 cells or laminate may collect light traveling at least partially across inner sheets 8 and through the gap of the spacer 12 sink and incident on the surface of PV 37 cells. PV 37 cells or laminate may be electrically connected to power sources 17 and/or 19, for example, to provide power to sensing device 14 and transmitter 16, respectively, or any other electrical components in glazing unit 2.

In one embodiment, glazing unit 2 may include one or more electric or electronic light blockers or shade(s) 35 to reduce heat gain across glazing unit 2. Electronic shade(s) 35 may be activated and/or deactivated (to shade) or activated and/or deactivated (not to shade) or partially activated, e.g., within a continuous range or “dial” of activations levels (to partially shade along a range of shade levels), when sensing device 14 senses a condition in a corresponding threshold range within chamber 10. Electronic shade(s) 35 may include, for example, LCD shades or an electro-active laminate shade disposed on a surface of outer sheets 4 and 6 and/or inner sheets 8. Electronic or electric shade(s) 35 may be manufactured by Research Frontiers, Inc., Sage Electrochromatics, Citala, although other products or manufacturers may be used. For example, shade(s) 35 may include SPD-Smart Glass™. Electronic shade(s) 35 may also be controllable via a battery powered or self-powered remote control with an on/off or variable setting control, e.g., manufactured by Echoflex, although other products or manufacturers may be used. In one embodiment, the remote control may override computer 20 controls based on conditions sensed by sensing device 14.

In another embodiment, glazing unit 2 may include one or more mechanical shade(s) 31 and/or 33 to reduce heat gain across glazing unit 2. A controller or processor (e.g., internal processor 29 or external processor(s) 11) may activate (fully or partially) or deactivate mechanical shade(s) 31 and/or 33 in response to data sensed within chamber 10 by sensing device 14. Mechanical shade(s) 31 and/or 33 may include, for example, mechanical screens, filters, or blinds. Mechanical shade(s) 31 and/or 33 may be disposed on one or both exterior surfaces of glazing unit 2, e.g., interior or exterior to a building or structure in which glazing unit 2 is installed, respectively. Additionally or alternatively mechanical shade(s) 53 may be disposed inside chamber 10 within glazing unit 2. Mechanical shade(s) 31 and/or 33 may be manufactured by Mechoshades, although other products or manufacturers may be used.

Electronic and/or mechanical shade(s) 31 33, and/or 35 may be controlled by glazing unit 2 via command signals from transmitter 16 or alternatively may be remotely controlled by computing device 20, remote server 28 and/or mobile device 26. Transmitter/transceiver 16 may receive command or control data from computing device 20, mobile device 26, or remote server 28 or other sensing devices 14 in other glazing units 2. Shade(s) 31 33, and/or 35 may include receivers coupled to transmitter 16, computing device 20, remote server 28 and/or mobile device 26. The receivers may be manufactured by EnOcean, although other products or manufacturers may be used.

Electronic and/or mechanical shade(s) 31, 33, and/or 35 may be activated, deactivated and/or partially activated, e.g., within a continuous range, when sensing for example device 14 senses a condition in a corresponding threshold range within chamber 10 (and an external controller reacts to the information sensed by device 14). Computing device 20, remote server 28 and/or mobile device 26 may automatically calculate the threshold ranges estimated to maintain desirable internal conditions in chamber 10. Computing device 20, remote server 28 and/or mobile device 26 may transmit threshold range data to glazing unit 2, e.g., via transmitter/transceiver 16. The transmitted threshold ranges may be predetermined or pre-set and programmed into a memory, e.g., written to a programmable chip processor 29. Alternatively or additionally, threshold ranges may be updated or adapted, e.g., set or re-set by a user in a programmable user interface or transmitted via wireless command by a computer or remote controller. In this way, shade(s) 31, 33, and/or 35 may be activated according to variable, adjustable, individualized or seasonally changing, parameters. Accordingly, an intelligent or learning network of glazing units 2 may be used to control shade(s) 31, 33, and/or 35, which may be adaptable to a history or individual conditions of each unit. Glazing units may communicate with each other to coordinate operations. For example, a first glazing unit 2 in an array of a number of glazing units 2 may sense a temperature change before the other units in the array, e.g., when the sun's rays move during a day. In this example, the first glazing unit 2 may signal the other units in the array to activate shade(s) 31 33, and/or 35 according to the data sensed in chamber 10 of the first glazing unit 2.

In some embodiments, an internal sensor such as sensing device 14 may include a radio device and may be programmed or re-programmed for example wirelessly, so that sensing device 14 is not limited to a fixed parameter set subject to the limitation of what is programmed before installation. Some advantages of such a configuration may include the creation of a smart learning network where data is collected and processed to determine that specific sensors parameters need adjustment.

When sensed temperature or pressure levels rise above or below a threshold range, a processor (e.g., internal processor 29 or external processor(s) 11) may activate and deactivate electronic shade(s) 35 according to the associated level of activation and/or deactivated. When electronic shade(s) 35 provide a continuous range of shading levels, there may be a one-to-one correspondence between each level of shading and the absolute values or changes in sensed condition thresholds that trigger the corresponding level of shading.

Sensing device 14 may include a GPS for providing a position and/or orientation of a glazing unit 2 for example relative to the sun. Processor 29 may include software or a look-up table in memory, which, based on the location of glazing unit 2, may determine the expected incidence of light rays from the sun at various times of the year. Processor 29 may adjust electronic shade(s) 35 and/or mechanical shade(s) 31 and/or 33 according to the expected incidence of light rays and/or other data from sensing device 14.

As shown in FIG. 1C, PV 37 cells or laminate may coat inner sheets 8 and/or outer sheets 4 and 6 on either surface of each sheet. PV 37 cells may be attached to sheets 4, 6 and/or 8 on either surface of each sheet. In one embodiment, PV 37 may be disposed in close proximity to power sources 17 and 19 and/or sensing device 14 and transmitter 16 to which PV 37 is electrically connected. In another embodiment, PV 37 may be attached to spacer 12 to minimize the visibility of the PV material. Other or different arrangements of PV 37 cells or laminate may be used.

Embodiments of the invention may initiate temperature control measures when a condition is first sensed in chamber 10, prior to other units which initiate temperature control measures, such as conventional room thermostats. E.g., a temperature rise may be detected before heat has propagated across the windows and into a room. Accordingly, embodiments of the invention may initiate temperature control measures before the condition affects or may be sensed within the room.

Sensing device 14 may communicate with external devices via transmitter 16 to operate other temperature control devices such as, heaters, air conditioners, humidifiers, etc., in response to the condition data sensed by sensing device 14. For example, temperature control devices may be programmed to respond to sensing device 14 data of environmental conditions within chamber 10 of glazing unit 2 instead of responding to conventional sensors (e.g., thermometers, barometers, etc.) placed in a room, which only measure conditions after they have propagated across glazing unit 2 and into the room.

Other sensors, arrangements or sensors, visualizations, displays, and sensory data may be used to monitor glazing units 2.

Structural Arrangement of Multi-Sheet Glazing Unit

Reference is made to FIGS. 2A and 2B, cut-away views of glazing unit 2 according to some embodiments of the invention.

As described, a glazing unit 2 may include outer sheets 4 and 6 and optionally, one or more inner sheets 8. Sheets 4, 6 and/or 8 may be oriented substantially parallel to each other and spaced apart by one or more spacer(s) 12. Spacers 12 are typically sealed along the peripheral edge of outer sheets 4 and 6 to form chamber 10.

Outer sheets 4 and 6 are preferably made of glass but may be of a rigid, e.g., non-permeable, plastic material such as a rigid acrylic or polycarbonate or may be other non-permeable and waterproof materials. Inner sheets 8 may be made of plastic, although glass may also be used. Polycarbonate materials and polyesters, such as polyethylene terephthalate (PET) may be used. Inner sheets 8 are typically rigid glass, although they may also be flexible thin film sheets. Sheets 4, 6 and/or 8 may be coated, tinted or pigmented to enhance appearance, alter light-transmission properties, increase insulation, control ultraviolet transmission, or reduce sound transmission. Sheets 4, 6 and/or 8 may also be laminated, tempered, etc. Outer sheets 4 and 6 and/or inner sheets 8 may include a power generator 27, e.g., to convert or transfer energy collected by PV 37 to charge power sources (e.g., power sources 17 and/or 19 of FIG. 1A) or directly power sensing device 14 and/or transmitter 16. Power generator 27 may additionally or alternatively generate power by mechanisms other than photovoltaic devices, e.g., using devices to convert temperature differentials or vibrations to power, by electrical induction or by induction using radio-frequency or other signals from an external induction source.

Compared with outer sheets 4 and 6, inner sheets 8 may be raised or spaced inward from one or more of the peripheral edges, or the bottom edge, of glazing unit 2 by a relatively greater distance than the outer sheets (the outer sheets may be raised or may not be raised at all). For example, inner sheets 8 may be spaced inward (e.g. towards the center of the unit) from at least one peripheral edge. Such spacing may protect the (typically) more fragile inner sheets 8 and may form a pocket or area for moisture to collect away from inner sheets 8. If moisture does collect in spacer 12 (either in an embodiment where this is permissible, or due to a failure of a structure or desiccant), moisture may collect in an area below an inner sheet 8, and thus moisture will not damage the inner sheet 8. Spacer 12 may further raise inner sheets 8 to protect the edge thereof by a gap 43 to provide an additional thermal barrier.

Glazing unit 2 may include adhesive or sealant 30, e.g., butyl sealant or other appropriate substance such as DOW 795, to structurally secure outer sheets 4 and 6 to spacer 12. Glazing unit 2 may include another adhesive or sealant 32, e.g., an adhesive tape such as very high bond (VHB™) tape by 3M™ or Norton™ or other materials, to further secure surfaces of outer sheets 4 and 6 to spacer 12. A non-permeable sealant 40 may resist moisture intake and insulating gas loss across sealant 30. Furthermore, a vapor bather 38 may be used to block moisture from passing through glazing unit 2, for example, to prevent moisture from entering chamber 10 via permeable or semi-permeable seals or cracks in non-permeable seals, which may develop over time. Vapor barrier 38 may be composed of a non-permeable material, such as, stainless steel or aluminum and may be sufficiently thin to be flexible enough to accommodate thermal expansion and contraction of glazing unit 2 to reduce stress on the unit seal. Vapor barrier 38 may also prevent or reduce heat transfer. A sealant 39, e.g., butyl sealant or another suitable substance may adhere vapor barrier 38 to spacer 12.

Sealants 30, 32, and 40 may be the same or different sealants and may be integrally or separately formed. In one embodiment, sealants 30 and 32 may primarily provide structural support while non-permeable sealant 40 may primarily provide a bather against moisture intake and gas loss from chamber 10, although each sealant may at least partially provide a barrier to moisture and gas as well as structural support. In one embodiment, non-permeable sealant 40 may be peripheral to sheets 4, 6 and/or 8 and sealants 30 and 32 so that, if a crack were to develop in non-permeable sealant 40, sealants 30 and 32 may fully or at least partially slow the passing of gas such as argon from leaving chamber 10 and moisture from entering chamber 10. Vapor barrier 38 may be peripheral to sheets 4, 6 and/or 8, and sealants 30, 32, 39, and 40, in glazing unit 2 to protect the seals, sealants, and chamber 10 between the sheets, from the passing of moisture and gas. Furthermore, sealants 30, 32, and 40 may be spaced from chamber 10, e.g., by spacer 12, so that if moisture were to penetrate the sealants (e.g., upon failure of the edge seal), the moisture would collect outside of chamber 10. In contrast, other units typically enclose an air chamber with sealant so that any moisture that passes the seal is instantly visible on the surfaces of glass lining the air chamber. Accordingly, the arrangement of sealants 30, 32, and 40 may reduce the visibility of the moisture as compared with other units.

Reference is again made to FIG. 2B and is made to FIG. 2C, which schematically illustrates a portion of FIG. 2B according to some embodiments of the invention. In FIGS. 2B and 2C, outer sheets 4 and 6 are raised or spaced inward from the peripheral edge of glazing unit 2. In one embodiment, inner sheet 8 may be spaced or raised from the edge by a relatively greater distance than outer sheets 4 and 6 (although inner sheet 8 may alternatively be spaced by a smaller distance or the same distance as outer sheets 4 and 6). Sealant 40 may fill the gaps between outer sheets 4 and 6 and vapor barrier 38. In one embodiment, one or more backer rods 34, e.g., non-permeable rings, may encircle and separate sealants 30 from sealants 40. Backer rods 34 may be disposed laterally inward from sealant 40 and vertically peripheral to sealant 30. Backer rods 34 may isolate sealant 40 to the plane(s) of outer sheets 4 and 6 and preferably not across the lateral width of glazing unit 2. There may be a ring of sealant 40 in the plane of outer sheet 4 and a separate ring of sealant 40 in the plane of outer sheet 6 and no sealant 40 laterally between the separate rings. Since outer sheets 4 and 6 and backer rods 34 are preferably composed of a non-permeable material (e.g., glass and plastics), if sealant 40 fails, outer sheets 4 and 6 may provide a non-permeable barrier to gas and moisture, e.g., in the vertical direction and backer rods 34 may provide a non-permeable barrier to gas and moisture, e.g., in the lateral direction. In this way, gas and moisture passing through sealant 40 may be blocked from passing to sealants 30, 32 and 39 or to chamber 10.

Reference is made to FIG. 2D, which schematically illustrates a non-permeable sealed edge of glazing unit 2 for deflecting moisture from entering the unit according to an embodiment of the invention. Glazing unit 2 may include a frame 59. In some situations, water 49 and moisture 47 may collect in frame 59 outside of the sealed edge of glazing unit 2. Moisture 47 may be initially deflected by vapor barrier 38. However, were moisture 47 to pass vapor barrier 38 and then sealant 40, e.g., due to a tear, crack or leak, outer sheets 4 and 6 and backer rods 34 may provide an final impermeable barrier to prevent moisture 47 from entering chamber 10, e.g., as described in reference to FIGS. 2B and 2C.

FIGS. 2B-2D show an embodiment where bond breaker tape 45 may be provided on incident surfaces of spacer 12 and a sealant assembly (e.g., sealants 30 and 40 and breaker rod 34). Bond breaker tape 45 may prevent sealants from directly adhering to spacer 12 so that the sealants may expand and contract with a different thermal expansion than spacer 12 without putting strain or stress on the sealants. In some embodiments, bond breaker tape 45 may be provided on surfaces between sealants and any structure having a different thermal expansion.

Other arrangements of sealants and vapor barriers may be used.

Reference is made to FIG. 3, which schematically illustrates a spacer according to some embodiments of the invention. Spacer 12 may be composed of metal, plastic, foam, vinyl or composite (e.g., plastic plus fiberglass, plastic plus metal), etc., and is preferably insulating. Spacers 12 may have hollow interiors, and in some embodiments contain desiccant 44 in order to prevent buildup of moisture in the space of chamber 10. Spacer 12 may have serrations, perforations, or holes 25 on a surface (e.g., surface 9) adjacent to chamber 10 to allow desiccant 44 to dehydrate the air in chamber 10.

Spacers 12 may have substantially “U” shaped, rectangular or square cross-sections. The “U” shaped spacer 12 may support and cradle inner sheets 8. Spacers 12 may have a slanted surfaces 9 bridging the gap between inner sheets 8 and each outer sheet 4 and 6, e.g., as shown in FIGS. 2A-4. Alternatively, spacers 12 may have flat, horizontal, or perpendicular surfaces bridging the gap between inner sheets 8 and each outer sheet 4 and 6, e.g., as shown in FIGS. 1B, 1C, 2B-2D, and 5B. Slanted surfaces 9 may be slanted at an angle to provide sufficient surface area to structurally support inner sheets 8, while minimizing the “glass bite” or dark visible ring around glazing unit 2 formed along the surface area in which spacer 12 contacts outer sheet 4 and 6. The width from slanted surface 9 to the peripheral edge of glazing unit 2 (e.g., near vapor barrier 38) is greater near inner sheet 8, for example, approximately 20 millimeters, than near outer sheet 4 and 6, for example, approximately 16 millimeters. In another embodiment, a slanted surface may not be used and the surfaces bridging the gap between inner sheets 8 and each outer sheet 4 and 6 may be, e.g., horizontally level.

The arrangement of one more sensing devices 14 in glazing unit 2 may vary. In the embodiment of FIG. 2, sensing device 14 may be disposed within spacer 12. In one example, spacer 12 may have a casing including serrations, perforations, or holes for example to protect sensing device 14 from desiccant 44 that is loose. The casing may not be air-tight to maintain air communication with chamber 10. In another example, sensing device 14 and desiccant 44 may be separated, e.g., located in different regions of spacer 12. An internal or external desiccant 44 tube may provide air communication between sensing device 14 and chamber 10 so that the air being sensed has been dehydrated by desiccant 44.

In FIGS. 2C and 2D, a desiccant container or canister 55 may be provided in spacer 12. Desiccant canister 55 may be a self-contained replaceable container or cartridge filled with desiccant material. Desiccant canister 55 may be inserted into opening 42 of spacer 12, e.g., during the assembly of glazing unit 2 or when recharging desiccant 44. Desiccant canister 55 may include holes 57 or other air ventilation to allow desiccant material to dehydrate chamber 10. In one embodiment, desiccant canister 55 may be fitted to account for the shape of sensing device 14, opening 42 and/or other components within spacer 12. Desiccant material and/or canister 55 may be, for example, manufactured by Edgetech™, although other products or manufacturers may be used. For example, in one embodiment a silicone based desiccant is used which can be removed by pulling the entire piece, which acts as a rope, out of the holder.

Reference is made to FIG. 4, which schematically illustrates a glazing unit 2 having an opening 50 through which a conduit, valve or tube 46 may attach that is in air communication with chamber 10 according to an embodiment of the invention. The opening or tube 46 may allow and/or control air flow from the external environment into and out of chamber 10. In one example, tube 46 may include an open and close valve 51, but a valve may not be used. In another example, glazing unit 2 may only exchange air when tube 46 is connected to a cartridge 48, e.g., having a specific shaped pin or “key” to open an air flow valve.

Sensing device 14 may be disposed in a cartridge 48. To test the internal conditions of glazing unit 2, the sensing device 14 cartridge 48 may be attached to chamber 10 via the conduit or tube 46. In this way, the same sensing device 14 may be used to monitor multiple glazing units 2, thereby reducing the cost of installing individual sensing devices 14 in each glazing unit 2. A single multi-condition sensing device 14 or multiple individual condition-specific sensing devices 48 may be used to sense environmental conditions in chamber 10. In some embodiments, sensing devices 14 may be in communication with building systems such as lighting, heating, cooling and other systems to optimize the building environment, possibly saving energy.

Multi-Sheet Glazing Unit Repair and Maintenance

Embodiments of the invention include glazing unit 2 having easily removable parts adapted for removal or repair while the unit is on site to decrease the cost of maintenance. Certain embodiments may include combinations of the features discussed, but not all features need be included. For example, a glazing unit 2 having a special spacer for easily replacing desiccant need not have a sensing device.

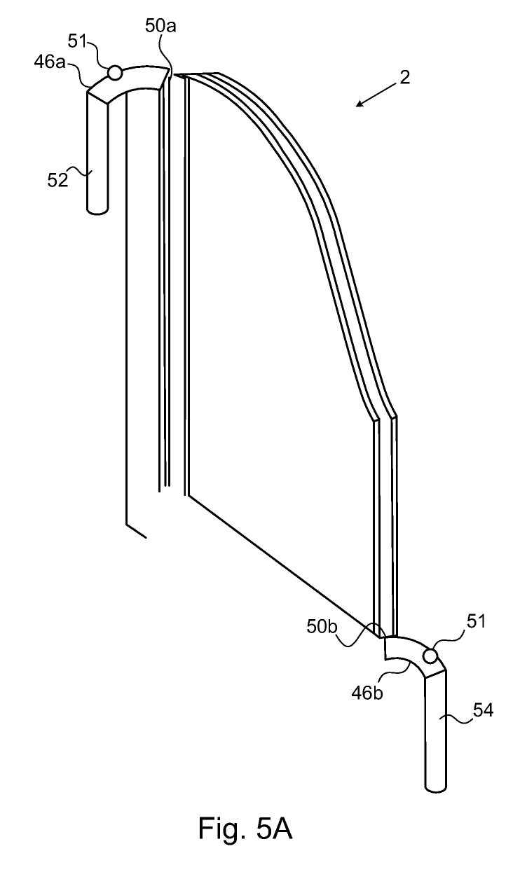

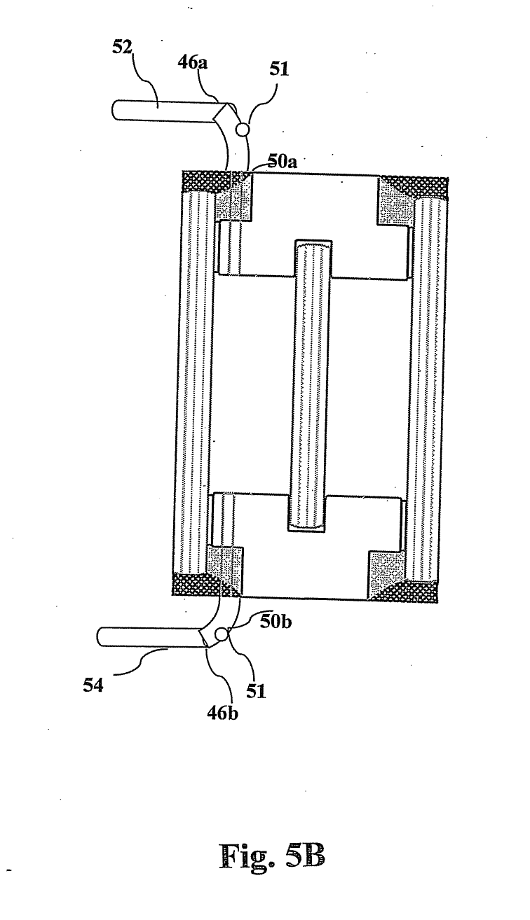

When the sensing device 14 indicates sub-optimal pressure or moisture levels, it may be because external air has entered glazing unit 2 over time, e.g., through a crack in the seal of glazing unit 2. There may be other reasons for environmental measurements outside acceptable parameters. Typically environmental air is less insulating than the heavier-than-air gasses, such as argon, krypton, or N₂ with which glazing unit 2 may be originally filled. In such a case, the air that leaked in should be replaced with a new supply of the insulating heavier-than-air gasses. The heavier-than-air gasses may be supplied to chamber 10 while it is installed (e.g., after manufacturing and installation) via a conduit or tube 46, as shown in FIGS. 5A and 5B, eliminating the need for a costly de-installation, repair, and re-installation. Reference is made to FIGS. 5A and 5B, which schematically illustrate a gas supply device 52 (e.g., an argon or krypton gas tank) and/or an air suction device 54 for re-filling chamber 10 with insulating gasses according to an embodiment of the invention. When the heavier-than-air gasses fill chamber 10, the heavier-than-air gasses typically sink and push down the external air that has entered glazing unit 2. Thus, the external air will leave the unit via second conduit or tube 46b. In one embodiment, a first conduit or tube 46a may be connected to chamber 10 via for example a hole 50a at the top of glazing unit 2 for filling chamber 10 with heavier-than-air gas and a second conduit or tube 46b may be connected to chamber 10 via a hole 50b at the bottom of glazing unit 2 for collecting or releasing the air. In another embodiment, the heavier-than-air gasses may be supplied using second tube 46b and collected using first tube 46a. Each of tubes 46a and 46b may include user-activatable valves 51 or plugs for preventing escape of the heavier-than-air gas after refilling. In some embodiments, air suction device 54 and/or second tube 46b need not be used and air may exit glazing unit 2 via hole 50b.

When the sensing device 14 indicates sub-optimal moisture levels, desiccant 44 may be partially or entirely saturated and should be replaced. In one embodiment, a cartridge 48 filled with desiccant 44 external to glazing unit 2 may be attached to the unit via an extending tube 46. In this embodiment, to change desiccant 44, air communication through tube 46 may be temporarily stopped, e.g., by closing valve 51, the old desiccant 44 cartridge 48 may be detached from tube 46, a new desiccant 44 cartridge 48 may be attached tube 46, and air communication through tube 46 may be restarted, e.g., by releasing or opening valve 51.

Alternatively or additionally, desiccant 44 may be disposed within glazing unit 2, e.g., in spacer 12. In one embodiment shown in FIG. 3, spacer 12 may include an accessible slot or opening 42 through which desiccant 44 may easily be replaced, e.g., as granules or contained in cartridge 48.

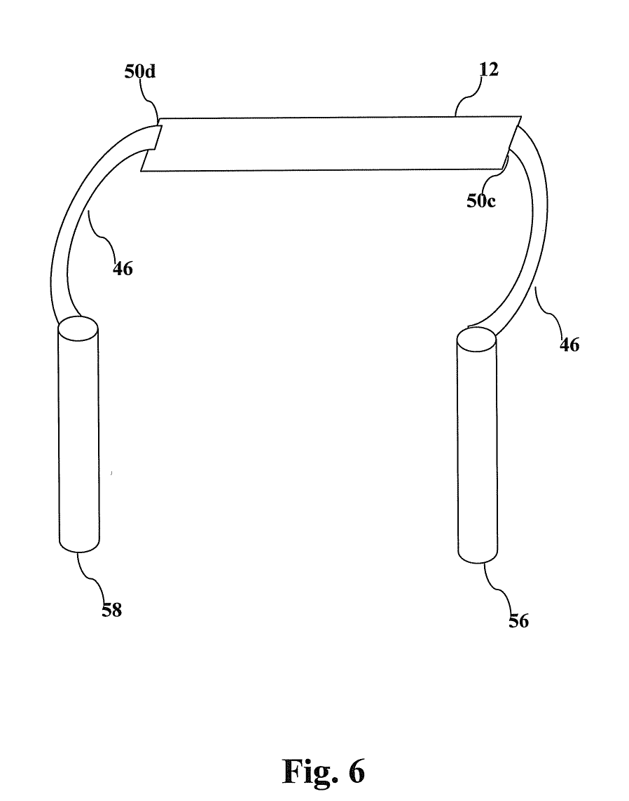

In another embodiment shown in FIG. 6, pumps may be used to force desiccant 44 out of spacer 12. Desiccant 44 may be in loose granular or powder form, and thus may be flowable. Reference is made to FIG. 6, which schematically illustrates an inflation device 56 and/or suction device 58 attached used to pump desiccant 44 out of spacer 12 according to an embodiment of the invention. For example, to remove desiccant 44, two conduits or tubes 46 may be attached to respective openings or holes 50c and 50d on opposite ends of spacer 12, or on opposite ends of a desiccant 44 chamber or portion of spacer 12. The pump devices 56 and 58 may create a pressure differential across spacer 12 by blowing or increasing the pressure (by inflation) at one end of spacer 12 and/or decreasing the pressure (by suction) at the other end of spacer 12. In this way, desiccant 44 may be forced or blown from the higher to lower pressure regions of spacer 12, i.e., away from first hole 50c and out second hole 50d. For example, to refill desiccant 44, second hole 50d may be closed and new desiccant 44 may be pumped into spacer 12. Once spacer 12 is filled, first hole 50c is closed. When desiccant 44 is being pumped, spacer 12 should be sealed to prevent residue from settling on sheets 4, 6 and 8. Spacer 12 may have serrations, perforations, or holes 25 on a surface (e.g., surface 9) adjacent to chamber 10 to allow desiccant 44 to dehydrate the air in chamber 10. The serrations, perforations, or holes are typically smaller than the granules or pellets of desiccant 44 to prevent desiccant 44 from entering chamber 10.

In another embodiment, a desiccant 44 cartridge 48 is fit into a slot in spacer 12. In another embodiment, spacer 12 may have openings or a less-than-air-tight seal to provide air communication between desiccant 44 cartridge 48 and chamber 10. In another embodiment, spacer 12 may form an air-tight-seal with an expandable bladder that allows air-communication between desiccant 44 cartridge 48 and chamber 10 without putting strain or stress on the peripheral edge seal of glazing unit 2. When chamber 10 is filled with insulating gas, an air-tight seal may be used to prevent air from the external environment from seeping into chamber 10. Accordingly, when spacer 12 is disassembled to replace desiccant 44 cartridge 48, the openings of spacer 12 should be temporarily sealed. Glazing unit 2 may have a lever or switch to close off the openings to change the desiccant 44 cartridge 48. In one example, desiccant 44 cartridge 48 may be released from spacer 12 by an unlocking mechanism, e.g., by twisting a cylindrical shaped desiccant 44 cartridge 48 clockwise or counter-clockwise or by moving a lever into a release position. The unlocking mechanism may provide a temporary seal to chamber 10, for example, by sealing spacer 12 openings, for example, by a rotating or sliding disk, slot, plugs, or other sealing mechanism. Once the desiccant 44 cartridge 48 is unlocked and chamber 10 is sealed, desiccant 44 cartridge 48 may be removed and replaced by a new desiccant 44 cartridge 48. The desiccant 44 cartridge 48 may be locked into spacer 12 by a locking mechanism that re-seals chamber 10, for example, by twisting the cylindrical shaped desiccant 44 cartridge 48 in the opposite counter-clockwise or clockwise direction or by moving a lever into a sealed position. Other release mechanisms may be used.

A desiccant 44 cartridge 48 that is external to glazing unit 2 is typically used with an un-sealed chamber 10 in air communication with the external environment to allow air passing through cartridge 48 to be dehydrated. An external desiccant 44 cartridge 48 is typically not used when chamber 10 is enclosed or hermetically sealed.

Manufacture of Multi-Sheet Glazing Unit

Reference is made to FIG. 7A, showing operations of manufacturing a multi-sheet glazing unit such as unit 2 according to a first embodiment of the invention. The operations of FIG. 7A may be used with units other than those shown herein.

In step 701, a spacer (e.g., spacer 12 of FIG. 2A) is provided. The spacer may have holes (e.g., holes 25 of FIG. 2A) on a surface adjacent to or in contact with an air chamber (e.g., chamber 10 of FIG. 2A). The holes may allow desiccant material in the spacer (e.g., desiccant 44 of FIG. 3) to dehydrate the air in the chamber. The holes are typically smaller than the granules or pellets of the desiccant material to prevent the desiccant material from entering the chamber.

In step 702, a sensing device (e.g., sensing device 14 of FIG. 1A), a transmitter (e.g., transmitter 16 of FIG. 1A), and one or more power source(s) therefore (e.g., power sources 17 and 19, respectively, of FIG. 1A) are provided in the spacer. In one embodiment, a power generator (e.g., power generator 27 of FIG. 2A) is also provided in the spacer.

In step 703, one or more inner sheets (e.g., inner sheet(s) 8 of FIG. 1A) are provided. The inner sheets may be supported by the spacer provided in step 701. Other methods of support and other arrangements are possible. In one embodiment, the spacer may have substantially “U” shaped opening to support the inner sheets. The inner sheets may be secured to the spacer using for example tension connections such as springs or rigid connection.

In step 704, an adhesive or sealant (e.g., sealant 32 of FIG. 2A) may be applied to the outer edges of spacer to which outer sheets are to be secured.

In step 705, outer sheets (e.g., outer sheets 4 and 6 of FIG. 2A) are secured to the spacer via the adhesive or sealant applied in step 704. The outer sheets are preferably disposed in a parallel orientation to each other and to the inner sheet(s). In one embodiment, photoelectric (PV) cells or laminate (e.g., PV 37 of FIGS. 1B, 1C, and/or 2A) may be provided on one or more of the outer sheets, e.g., as film, tape, laminate, or cells of PV material. The PV cells or laminate may be disposed on the outer sheets, inner sheets and/or on the spacer or on a sensor 14, e.g., as shown in FIG. 1C.

In step 706, edge seals (e.g., edge sealant 30 of FIG. 2A) may be applied. The edge seals may bond the outer sheets and the spacer and fill the gap therebetween to add structural support and prevent moisture from entering the chamber.

In step 707, desiccant material (e.g., desiccant 44 of FIG. 3) may be provided. The desiccant material may be inserted into the spacer via a slot or opening (e.g., opening 42 of FIG. 3). The opening may be opened and closed to provide an entrance for filling the spacer with desiccant. The desiccant material may be replaced via the portal during the lifetime of the unit, e.g., when the desiccant is saturated.

In step 708, a vapor barrier (e.g., vapor barrier 38 of FIG. 2A) and an additional sealant (e.g., sealant 40 of FIG. 2A) may be provided. The vapor barrier may be used to block moisture from entering the chamber. The additional sealant may be use to seal the vapor barrier to the edge seals provided in step 706.

Other or additional arrangements of components or operations may be provided.

Reference is made to FIG. 7B, showing operations of manufacturing a multi-sheet glazing unit according to an embodiment of the invention. The operations of FIG. 7B may be used with units other than those shown herein.

In step 710, a spacer (e.g., spacer 12 of FIG. 2B) and one or more inner sheet(s) (e.g., inner sheet(s) 8 of FIG. 2B) are provided. A fitted groove in the spacer may be wrapped around or may accept inner sheet to support and cradle the sheet.

In step 711, outer sheets (e.g., outer sheets 4 and 6 of FIG. 2B) are secured to the spacer, for example, using an adhesive or sealant (e.g., sealant 32 of FIG. 2B). The outer sheets are preferably disposed in a parallel orientation to each other and to the inner sheet(s), but need not be.

In step 712, a sensing device (e.g., sensing device 14 of FIG. 1A) and/or desiccant material (e.g., desiccant canister 55 of FIGS. 2C and 2D) may be inserted into an opening (e.g., opening 42 of FIG. 3) in the spacer.

In step 713, a sealant assembly is provided to enclose a chamber between the sheets. The sealant assembly may provide a non-permeable edge to form a sealed glazing unit (e.g., glazing unit 2 of FIG. 2B). The sealant assembly may include sealants 30, 32, 39, and 40 of FIG. 2B.

Other or additional arrangements of components or operations may be provided.

Method of Operating Multi-Sheet Glazing Unit

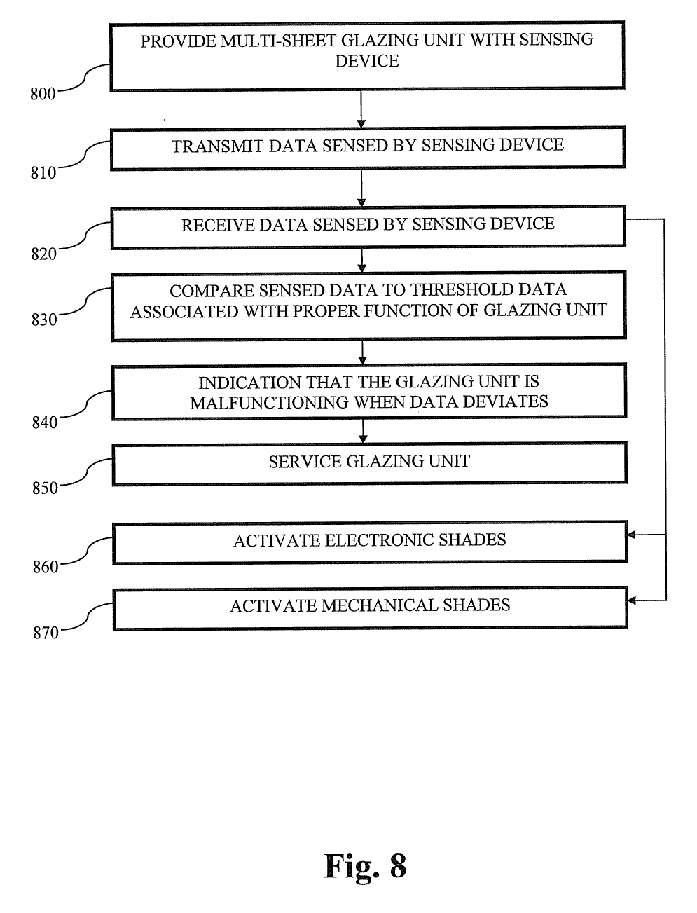

Reference is made to FIG. 8, which is a flowchart of a method according to an embodiment of the invention.

In operation 800, a multi-sheet glazing unit is provided with a sensing device. The unit may be as described above, but other types of units may be used with embodiments of the present invention. The air space may be fully enclosed, partially enclosed or open to the unit's external environment. When the air space is fully enclosed, the air space or gap may be filled with an insulation gas, such as, argon or krypton. The sensing device may be in air communication with the air space for sensing an environmental condition data in the air gap. The sensing device may sense an environmental condition not specifically in the air in the air gap—e.g. the temperature of a solid structure, or the presence or water. The environmental condition data may include for example pressure, humidity, air density, thermal conductivity, temperature, vibrations, and shock.

In one embodiment, the sensing may be disposed in the spacer. In another embodiment, the sensing may be located outside the glazing unit and connected to the air gap via an extending conduit or tube. For example, the sensing device may be a sensing device cartridge that is easily attachable to and detachable from the glazing unit.

In operation 810, a transmitter coupled to the sensing device may transmit the sensed data, e.g., to a remote receiver. The transmitter may be disposed within or external to the glazing unit. The transmissions may be wireless. In one embodiment, the transmitter may be or include an RFID tag. The RFID tag may be triggered to transmit RFID tag signals by an external power source, such as a mobile radio-frequency scanner.

In operation 820, a remote receiver may receive the sensed transmitted data. The remote receiver may be coupled to a computing device, a server, and/or a mobile device. The sensed data may be transferred between the devices. In some embodiments, the sensed data may be stored in the server and downloaded to the computing device.

In operation 830, the computing device may process the sensed data to monitor the glazing unit. The computing device may compare the sensed data with predetermined limit, threshold or range data associated with the proper function of the glazing unit. In some embodiments, extensive processing is not performed, and the data is displayed after minimal or no processing to a user.

In one embodiment, the computing device may compare the sensed data at some or all of a plurality of stages of manufacture of the glazing unit (e.g., manufacturing steps 701-708 of FIG. 7) with a predetermined threshold, limit or range data. The stages of manufacture may be associated with the structural components in the glazing unit, the facilities where the particular stage of manufacture was executed, the assembly steps in an assembly line, and/or individual technicians.

In operation 840, a maintenance device (e.g., the computing device and/or a mobile device) may provide an indication that the glazing unit is malfunctioning or operating against specification when the data sensed by the sensing device deviates from predetermined threshold values associated with the proper function of the glazing unit. The indication may include an alarm, signal, or alert message. When the sensed data is analyzed at each of a plurality of stages of manufacture of the glazing unit and the sensed data at one or more of the stages of the manufacture substantially deviates from the predetermined threshold data, the maintenance device may indicate to a user a potential malfunction warning for the unit and/or the one or more stages of the manufacture at which the deviation occurred.

In operation 850 (possibly based on an indication provided in operation 840, if used), a maintenance technician may service the glazing unit, for example, by refilling the gas, replacing the desiccant, or repairing the unit. Alternatively, the unit may include automatic maintenance components, e.g., pressure release or suction valves, activated in response to the maintenance indication in operation 840. The automatic maintenance components may be automatically activated, for example, by environmental conditions such as pressure gradients across the release or suction valves or by electronic control. The automatic maintenance components may operate to maintain stable environmental conditions thresholds within the air space or gap of the unit.

In operation 860, one or more electric or electronic shade(s) (e.g., shade(s) 35 of FIG. 1) may be activated (to shade) or deactivated (not to shade) or partially activated, when data received from sensing device in operation 820 corresponds to respective corresponding predetermined threshold ranges. Shade(s) may be disposed on one or more sheets of the glazing unit.

In operation 870, one or more mechanical shade(s) (e.g., mechanical shade(s) 31 and/or 33 of FIG. 1) may be activated (to shade) or deactivated (not to shade) or partially activated, when data received from sensing device in operation 820 corresponds to respective corresponding predetermined threshold ranges. Mechanical shade(s) may be disposed on one or both exterior surfaces of the glazing unit.

Other operations or series of operations may be used. For example, in an embodiment where mere data display is desired, operation 840 need not be used.

Although some embodiments described above relate to a glazing unit with an enclosed air gap, it may be appreciated that these embodiments may be similarly applied to glazing units having a partially enclosed air gap (either by design or due to cracks in the seal that fond over time) or an open air gap in air communication with the unit's external environment (e.g., via a tube or conduit, or an opening). The predetermined threshold data associated with the proper function of the glazing unit may differ depending on whether the unit's air gap is fully enclosed, partially enclosed or open to the unit's external environment. However, regardless of the type of air gap, the glazing unit's sensory data may be compared with the corresponding predetermined proper function threshold data to determine malfunctions in the unit.

Although some embodiments described above relate to the wireless transfer of data from a sensing device inside a glazing unit to an external device, it may be appreciated that embodiments may include wired connections and data transfer. For example, in reference to FIG. 1A, a temporary wired connection may be used to connect or plug in mobile device 26 into glazing unit 2 to collect data via a physical connection between mobile device 26 and sensing device 14 or transmitter 16. In another example, a permanent or long-term wired connection may be used to, e.g., to power sensing device 14 and transmitter 16 via a power source external to glazing unit 2. Other physical or electrical connections may be used.

Various embodiments are described herein, with various features. In some embodiments, certain features may be omitted, or features from one embodiment may be used with another embodiment. Modifications of embodiments of the present invention will occur to persons skilled in the art. All such modifications are within the scope and spirit of the present invention as defined by the appended claims.

1. A system, comprising:
a multi-sheet glazing unit comprising:
two or more sheets oriented by a spacer in a substantially parallel and spaced apart relationship, the sheets having a peripheral edge and an air space therebetween; and
a sensing device in air communication with or disposed within the air space for sensing an environmental condition in the air space.

2. The system of claim 1, comprising a transmitter coupled to the sensing device to transmit data associated with the sensed data.

3. The system of claim 2, wherein the transmitter is a wireless transmitter.

4. The system of claim 3, wherein the transmitter comprises a radio-frequency identification (RFID) tag that transmits the data sensed by sensing device.

5. The system of claim 1, further comprising a computer device for processing data sensed by the sensing device.

6. The system of claim 5, wherein the computer device is adapted to provide an indication that the glazing unit is malfunctioning when the data sensed by the sensing device deviates from predetermined threshold values associated with the proper function of the glazing unit.

7. The system of claim 6, wherein the indication includes an alarm, signal, or alert message.

8. The system of claim 6, comprising desiccant material, wherein when the indication is provided the desiccant material is to be replaced.

9. The system of claim 1, comprising one or more inner sheets provided between the outer sheets, wherein the inner sheets are spaced inward from at least one peripheral edge.

10. The system of claim 1, wherein the environmental condition is selected from the group consisting of: pressure, humidity, air density, thermal conductivity, temperature, vibrations, and shock.

11. The system of claim 1, further comprising a remote server for storing the data sensed by the sensing device.

12. The system of claim 1, further comprising electronically activated shades, wherein the shades are activated in response to the sensing device sensing an environmental condition in the air space.

13. A method for maintaining a multi-sheet glazing unit, the method comprising:
in a multi-sheet glazing unit:
sensing environmental condition data in an air space within the unit; and
transmitting the sensed data to a remote receiver.

14. The method of claim 13, wherein the transmitting is wireless.

15. The method of claim 13, wherein the transmitting is performed using an RFID device.

16. The method of claim 13, wherein the transmitting is triggered by an external power source.

17. The method of claim 13, wherein the environmental condition is selected from the group consisting of: pressure, humidity, air density, thermal conductivity, temperature, vibrations, and shock

18. The method of claim 13, comprising indicating that the glazing unit is malfunctioning when the data sensed by the sensing device deviates from predetermined threshold values associated with the proper function of the glazing unit.

19. A method for monitoring a plurality or multi-sheet glazing units, the method comprising:
sensing an environmental condition within one of the glazing units, each unit having an air space formed between two or more sheets oriented by a spacer, the sheets in a substantially parallel and spaced apart relationship, wherein the data is sensed by a sensing device.

20. The method of claim 19, wherein the environmental condition is selected from the group consisting of: pressure, humidity, air density, thermal conductivity, temperature, vibrations, and shock.

21. The method of claim 19, comprising: transmitting the sensed data wirelessly to a remote receiver.

22. The method of claim 19, wherein the transmitting uses RFID signals

23. The method of claim 19, comprising storing the sensed data in a remote server.

24. The method of claim 19, comprising indicating that the glazing unit is malfunctioning when the data sensed by the sensing device deviates from predetermined threshold values associated with the proper function of the glazing unit.

25. The method of claim 19, comprising:
in a computing device:
comparing the sensed data at each of a plurality of stages of manufacture of the glazing unit with a predetermined threshold data associated with the proper function of the glazing unit; and
if the sensed data at one or more of the stages of the manufacture substantially deviates from the predetermined threshold data, indicating to a user a potential malfunction warning for the unit and the one or more stages of the manufacture at which the deviation occurred.

26. The method of claim 19, wherein one or more stages of the manufacture of the glazing unit is associated with one or more elements from a group consisting of: structural components in the glazing unit, facilities where the particular stage of manufacture was executed, assembly steps in an assembly line, and individual technicians.
